(19) United States
(12) Patent Application Publication
(10) Pub. No.: US 2010/0257038 A1
(43) Pub. Date: Oct. 7, 2010

(54) Dynamic Delivery and Use of Electronic Incentives

(76) Inventor: Blake Shipley, Cincinnati, OH (US)

Correspondence Address: FROST BROWN TODD, LLC, 2200 PNC CENTER, 201 E. FIFTH STREET, CINCINNATI, OH, 45202, US

(21) Appl. No.: 12/543,848

(22) Filed: Aug. 19, 2009

Related U.S. Application Data
(60) Provisional application No. 61/165,722, filed on Apr. 1, 2009.

(51) Int. Cl. G06Q 30/00

(52) U.S. Cl. 705/14.16; 705/14.25

(57) ABSTRACT

A host system for a merchant to distributing and redeeming incentives to a consumer is provided. The merchant may create an incentive with specifications that determine the value of the incentive and to which consumers the incentive is available. The consumer may create a list of products, which the host system matches to a database of created incentives. The consumer may select and use one of more of the incentives and also may share incentives with other consumers. The host system also provides for the verification and confirmation of incentive use, thus allowing the issuer and the host system to track incentive efficiency. The host system also allows for dynamic incentive value determination based on consumer activity, such as sharing the incentive, incentive usage, reviewing products, or posting in a forum.

### PRIORITY

This application claims priority from the disclosure of U.S. Provisional Patent Application Serial No. 61,165,722, entitled “Intelligent Shopping System,” filed Apr. 1, 2009, which is herein incorporated by reference in its entirety.

### FIELD OF THE INVENTION

This invention relates to the electronic issuing, distributing, redeeming and clearing of promotional incentives. More particularly, this invention relates to a data processing system and method for electronically defining, issuing, distributing, displaying dynamically to a consumer user, redeeming and clearing promotional incentives whose characteristics are dynamically obtained as a function of demographics, behavior history, and other characteristics of the consumer user and other such properties.

### BACKGROUND

It is common practice for businesses to provide incentives to consumers to buy products or services or to provide incentive for particular consumer behavior by offering promotions such as discounts, coupons, prizes, etc. Common examples of incentives are discount coupons that consumers can present to claim the discount when they purchase products or services. These incentives are designed primarily to increase sales of the business and, therefore, coupons are issued by a business and the cost of any discount or incentive is absorbed by the business. Manufacturers and franchisors also issue coupons for discounts on their products with the hope of expanding the market for those products. Consumers may redeem the coupons with businesses selling the product. The businesses in turn are reimbursed by the manufacturer or franchiser who issued the coupon.

Printed coupons are by far the most common coupon in use today. Approximately 340 billion coupons are printed each year in the United States alone, and advertisers have relied on many different ways to deliver those coupons. Currently, the favored method is distributing printed coupons through mass media, such as magazines or newspapers, or through direct mailing, either as an insert or dimensional mail piece. Coupons inserted in newspapers constitute the vast majority of the coupons distributed primarily because of their extremely low cost—approximately $0.007 per coupon.

A substantial portion of all coupons distributed are never viewed by their intended audience for one reason or another. Many consumers receiving a coupon may have no interest in the advertised goods, or they may not be able to afford them. There also is a general clutter of advertisements that makes it difficult for a particular coupon to capture the attention of consumers, especially if a consumer is distracted or otherwise occupied when an opportunity for viewing the coupon arises. Thus, most coupons are not viewed and never redeemed. The average redemption rates for coupons distributed as newspaper inserts, by far the most common distribution method, are only about 1 percent. Because of that inefficiency, the effective cost for each advertising message that stimulates a desired consumer response is generally many times higher than the nominal cost per message.

Businesses are very concerned with using their promotion budget efficiently. They want to discount products at specific times, to specific consumers in such a way as to maximize the profit when the cost of the promotion and its effect on sales is taken into account. The optimal discount incentive, for example, is the smallest discount that will successfully motivate the consumer to purchase.

Determining the optimal incentive, for example, the optimal discount, might include several concerns such as current inventory, financial motivations, and consumer demographics. Inventory factors may include: the demand for the product which may vary even on a daily basis, for example in the hospitality industry; the cost of carrying the product; the remaining life of the product before it is superseded or upgraded; and so on. Financial factors include preferred timing for selling the product. For example, in some industries a company is more motivated to make a sale at certain points in the week, the month, the quarter or the year. Consumer factors include demographic characteristics, stated consumer interest, and past purchasing behavior. A company, for example, may want to provide a more valuable incentive to one type of potential customer (e.g., wealthier, more stable, more loyal, etc.) In addition, the optimal incentive system needs to be flexible, for example to enable several entities to be involved, and for any particular incentive to have one or more characteristics depend on the characteristics of one or more of these entities.

An alternative approach to paper coupons is for the company to call consumers individually on the telephone to present the offers. However, phone lists and call operators are expensive and this system does not allow the consumer to find the incentives at their own pace.

Various services “broadcast” e-mails that include coupons, or links to websites where coupons may be accessed to a list of e-mail addresses. There also are services that broadcast coupons as text messages to a database of telephone numbers. The cost of delivering coupons via broadcast systems may be relatively low, but the cost of collecting or otherwise obtaining lists of e-mail addresses or telephone numbers is quite high. Such services also do not offer consumers the ability to request coupons on demand. In fact, the vast majority of consumers receiving such broadcasts may have no interest in the products or no desire to receive promotional e-mails or text messages. The response rate for broadcast coupons, therefore, is usually very low.

Services have attempted to broadcast electronic advertising to a more targeted audience by providing “opt-in” services. That is, advertising is broadcast only to consumers who have elected to receive advertising. In theory this might suggest higher response rates, but in practice that is not necessarily so. Opt-in coupons typically are delivered according to a schedule predetermined by the service provider. Thus, the coupon may not be delivered at a time when a consumer is most receptive to the offer.

Some “opt-in” services allow a consumer to select predetermined criteria that will determine the types of coupons he will receive. The ability to select criteria, however, also may not significantly increase the likelihood that a consumer will receive a coupon in which he has an immediate interest. For example, a consumer may have opted-in to a service when he was thinking about taking a vacation. Unless the consumer has taken time to update his criteria, he will still receive offers on transportation, lodging and other travel related services long after he takes his vacation and his interest in such offers has waned. Both opt-in and broadcast systems are also highly susceptible to spam email detection software, thus reducing the likelihood for a particular coupon to capture the attention of consumers.

Accordingly, various systems have been devised to deliver electronic coupons on demand. Those systems offer the promise of delivering coupons to consumers when they are ready to make a purchase and, therefore, the promise of higher redemption rates. Those promises, however, remain largely unfulfilled. Such systems are most commonly web based, meaning a consumer is required to access a website to obtain coupons. Typically, as with most “electronic” coupons, they are printed from a website by the consumer.

In these systems, the server can display active coupon files to a customer who may then download coupons as desired. Coupons may be redeemed either by printing the coupon out at the customer's personal computer or by having the coupon stored electronically under the customer's name so that it can be redeemed at the store automatically.

Many of these systems, while adequate for distributing manufacturer coupons on a wide scale, are not well suited for distributing coupons on behalf of smaller, localized businesses. The system may be too expensive or ineffective for such businesses, especially to the extent that they distribute coupons to consumers who do not have a realistic opportunity to act upon the coupon.

Current electronic coupon systems also present businesses, manufacturers, and franchisors with a concern for fraud through the elimination of a paper trail confirmation of coupon use. That is, businesses accepting coupons may claim to have received a coupon from a consumer when in fact a consumer did not present a coupon. Also, an employee may falsely claim to have been presented with electronic coupons and could easily pocket the value of “phantom” coupons.

### BRIEF DESCRIPTION OF THE DRAWINGS

The accompanying drawings incorporated in and forming a part of the specification illustrate several aspects of the present invention, and together with the description serve to explain the principles of the invention; it being understood, however, that this invention is not limited to the precise arrangements shown. In the drawings, like reference numerals refer to like elements in the several views. In the drawings:

FIG. 1 shows an overview.

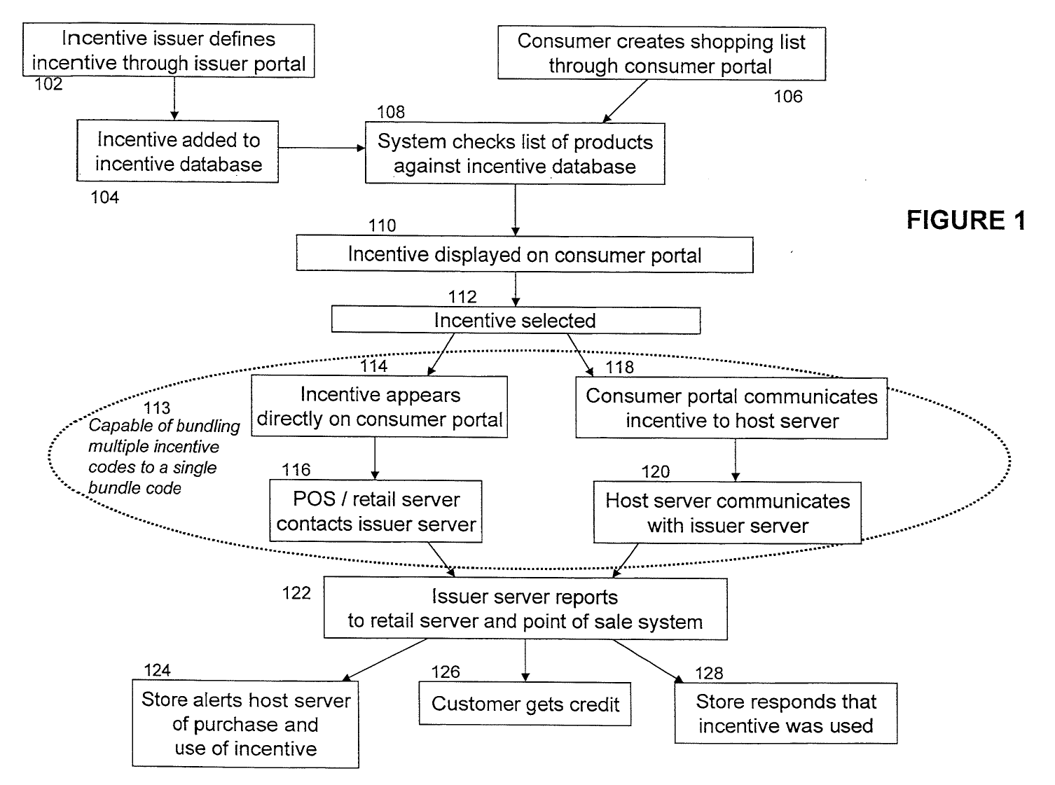

FIG. 2 shows the advertiser submission process.

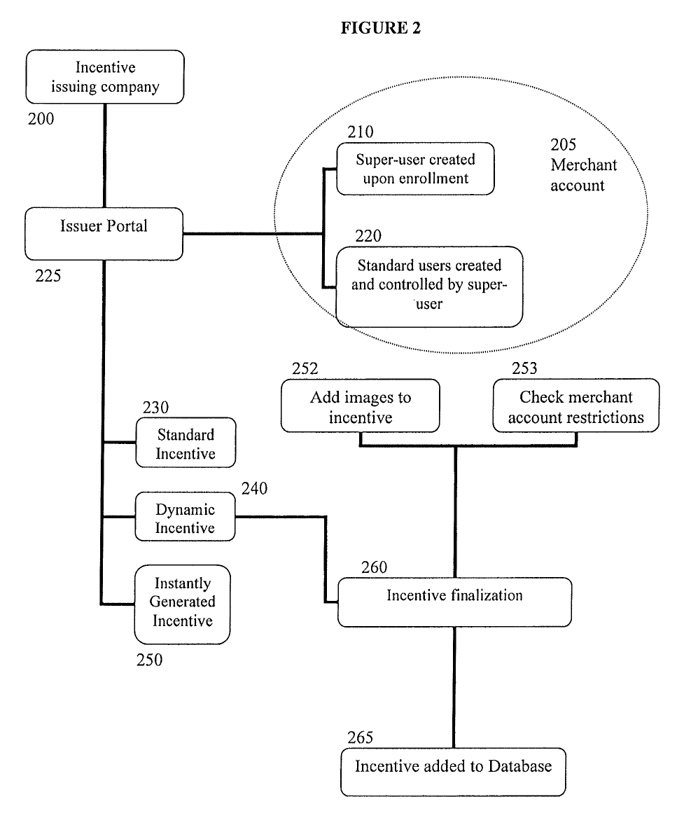

FIG. 3 shows a flow chart of the personalized consumer account process and the incentive display process.

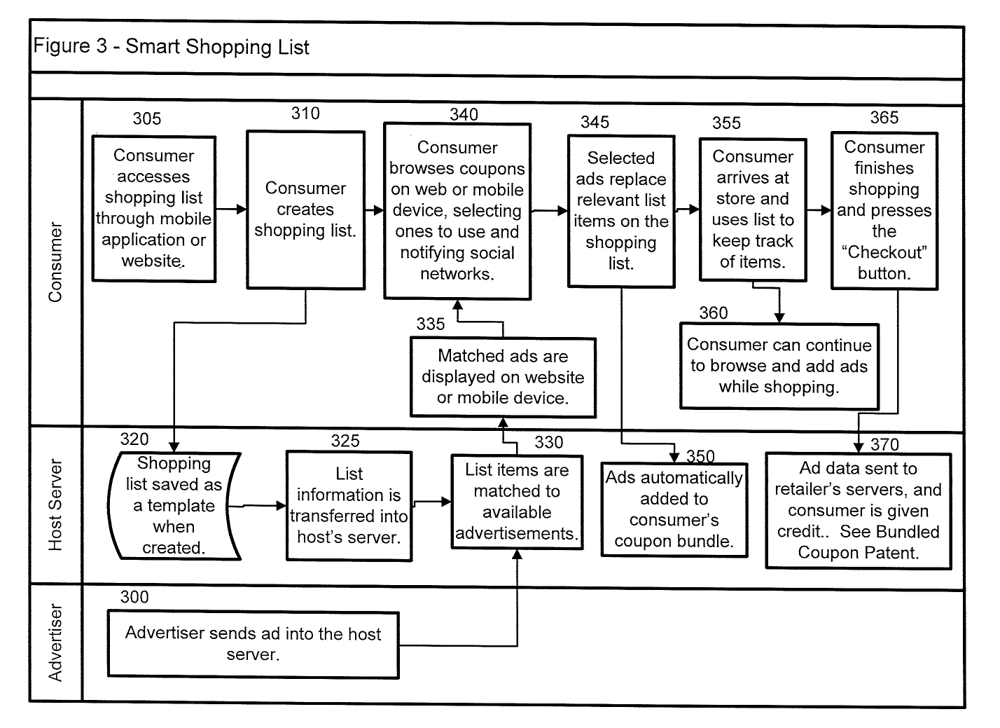

FIG. 4 shows a flow chart of the consumer checkout process for a single incentive.

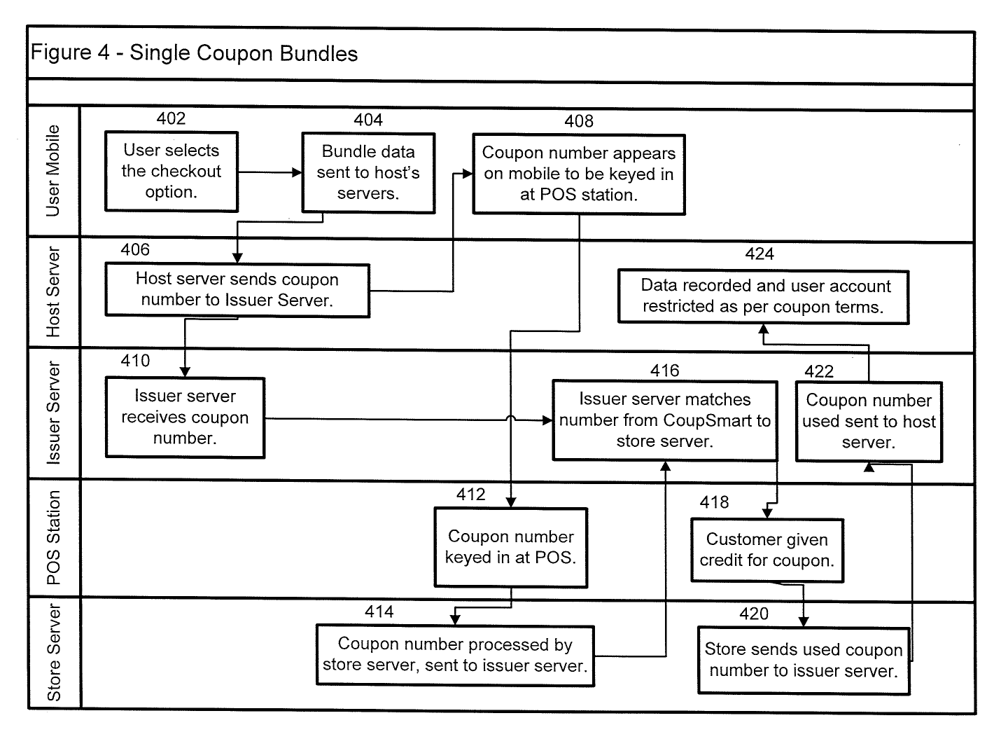

FIG. 5 shows a flow chart of the consumer checkout process for multiple incentives.

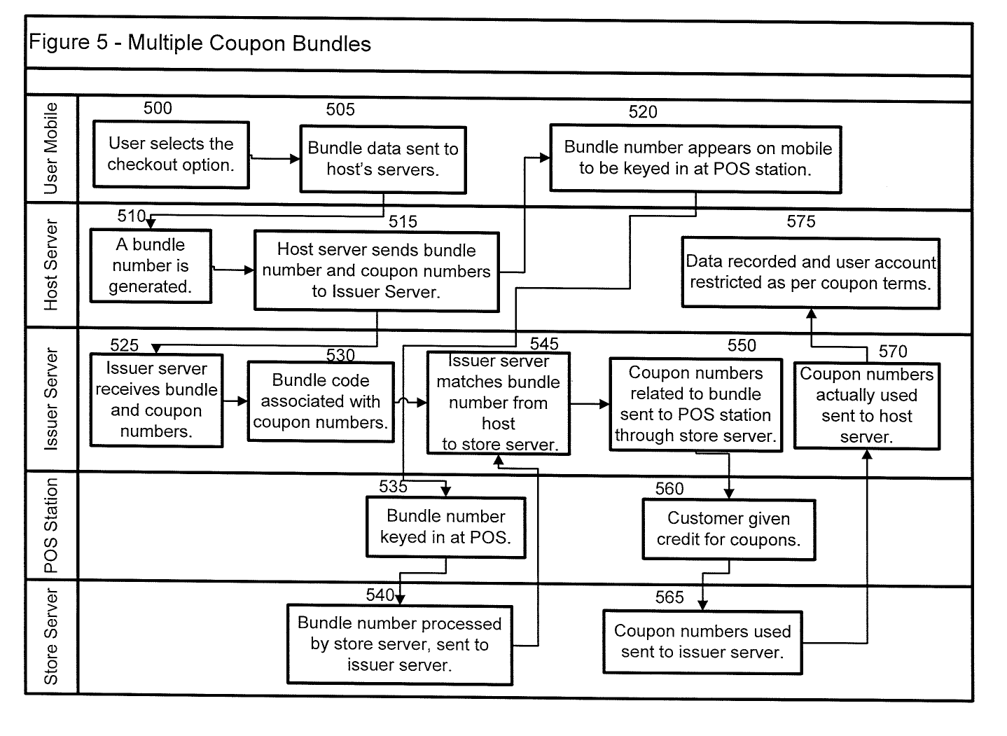

### DETAILED DESCRIPTION

The following description of certain examples of the current application should not be used to limit the scope of the present invention as expressed in the appended claims. Other examples, features, aspects, embodiments, and advantages will become apparent to those skilled in the art from the following description. Accordingly, the figures and description should be regarded as illustrative in nature and not restrictive.

Versions described herein disclose a system to create, issue, view, select, verify, and utilize an incentive with a dynamically determined value.

The system includes a host server with an issuer portal, incentive database, and a consumer portal. The issuer portal allows a merchant to generate an incentive and associate specifications with the incentive. The incentive database stores the created incentives. The consumer portal allows a consumer to create a list of desired products.

The host server then identifies at least one matched incentive by comparing the list of products to the plurality of incentives in the incentive database. The consumer portal then displays the matching incentives to the consumer and allows the consumer to select certain of the matched incentives.

The issuer server receives the selection from the host server and verifies the selection. After verifying the selection, the issuer server transmits the verification confirmation over the network. The retail server receives the selection from the consumer portal and the verification confirmation from the issue server. A network connecting the host server, the issuer server, and the retail server allows for data transmission.

The host system includes an issuer portal 102 that allows companies to issue incentives. The system stores incentives in an incentive database 104. The system contains a consumer portal 106 that allows a consumer user to create shopping lists and view incentives. The system matches products on the product list with incentives in the incentive database 108. The system displays matched incentives 110 to the consumer user through the consumer portal 106, and allows the consumer user to select 112 an individual or a group of incentives.

If a single incentive is selected, only that single incentive is transmitted. If the consumer selects more then one incentive, then the host system or the issuer server can associate a bundle code to represent the selected incentives 113. This bundle code can now be used by all parts of the system to identify the custom group of selected incentives.

The system transmits selected incentive information from the consumer portal 118 to the issuer server 120. Alternatively, the system displays an incentive code on a mobile device 114, which is entered at a retail store location and sent directly to the issuer server 116. The issuer server validates the incentive 122 and communicates to the retail establishment for crediting the consumer user 126 and communicating use of the incentive to the system, as shown in step 124, and the issuer server 128.

### Incentive Issuing Company Account Creation

An incentive issuing company 200 enrolls in the system. Upon confirmation the host system can establish a merchant account 205 for each company. The incentive issuing company 200 may be a retail business, manufacturer, franchisor, or a similar business that desires to offer an incentive for a consumer user to purchase a product. The confirmation process prevents fraudulent access to the system.

An issuer portal 225 allows the incentive issuing company 200 to access the system through a website, mobile device, or through similar means in order to control available incentives.

The merchant account 205 can include a merchant super-user 210 to manage incentive creation control specifications and merchant standard users 220. The merchant super-user 210 can manage merchant standard-users 220 through the issuer portal 225. The merchant super-user 210 can grant or restrict the ability of merchant standard-users 220 to create a standard incentive 230, dynamic incentive 240, or instantly generated incentive 250. If a merchant standard-user 220 is allowed to generate a type of incentive, the system can then check user restrictions 253 and only allow the merchant standard-user 220 to create incentives for certain products or for certain retail store locations as approved by the merchant super-user 210. It is also possible for the user security to be managed by the incentive issuer. In this case, the system recognizes a merchant super-user or standard users as designated by the super-user.

### Standard Incentives

The merchant standard-user 220 can create a standard incentive 230 by indicating certain information to issuer portal 225, such as the benefit of the incentive and the conditions under which the incentive is given. Examples of conditions for a standard incentive 230 include: the time frame over which the system will display the incentive, the incentive value, and the retail locations for redemption. For example, the specifications for a standard incentive 230 could be: 1) available at all retail locations for 2) $0.50 off 3) hotdogs 4) for the next two weeks.

### Dynamic Value Incentives

The system also allows merchant standard-user 220 to generate a dynamic incentive 240. A dynamic incentive 240 has a variable value, which depends on defined factors. The value can be based on a specified demographic, activity of the consumer user, or proximity of the consumer user to the retail premises. Activities affecting the incentive value can also include the consumer user contributing to community based forums and tagging, submitting reviews, sharing incentives, viewing incentives, and the consumer user's shopping and incentive redemption history. Dynamic value incentives give the incentive issuing company an additional method of controlling the advertising cost while enabling the company to encourage certain types of behavior in consumers at a marginal cost.

### Instantly Generated Incentives

The issuer portal allows the merchant standard-user 220 to create instantly generated incentives 250, which are localized or short term versions of the standard incentive 230 or dynamic incentive 240. An instantly generated incentive 250 allows the incentive issuing company 200 to discount, for example, a specific product that is overstocked in a particular store. The issuer portal 225 allows the merchant standard-user 220 to create an instantly generated incentive and to set any available parameter.

The issuer portal also allows the merchant standard-user 220 to enter the incentive parameters, such as the product name, the incentive value, and the time period during which the incentive is applicable. Once the incentive parameters are entered, the merchant standard-user 220 may be asked to confirm the entered information. As a part of this confirmation, the system may show the price of delivering the instantly generated incentive to the entire system.

The merchant standard-user 220 can then limit the scope of the incentive. The merchant standard-user has the option to specify certain consumer user parameters to limit the number of consumer users to which the incentive is offered. The issuer portal can display the number of consumer users that fit the selected user parameters and the total cost of the incentive based on that number of consumer users. The issuer portal can display options that increase or decrease the cost or reach of the advertisement.

The merchant standard-user 220 can add or remove consumer users based on their zip code, exact address, or a specific mile radius around a particular store to increase or decrease the number of targeted consumer users. The user can specify whether the incentive can be redeemed at a single store location or for multiple stores.

In one embodiment, the incentive can be limited to consumer users with certain purchase or incentive redemption histories. The incentive can also be limited to users with a specified incentive viewing history. The incentive can also be limited to specific consumer user personal preferences, as provided by the consumer user through the consumer portal. The incentive can also be limited to consumer users who complete specified activities such as filing out a profile or selecting certain preferences or sharing lists or incentives with other users.

The merchant user can also set a certain dollar amount as the incentive limit, and the issuer portal presents parameters that meet that dollar amount. For example, the system may select users based on the frequency of the consumer user using incentives for that company. The system may also include consumer user's previous activities such as: contributing to community based forums and tagging, submitting reviews, sharing incentives, viewing incentives, and the user's shopping and redemption history.

The merchant standard-user 220 may have the option add an image to the incentive 252 by submitting images or selecting images from a database of product images, marketing images, or company logos to associate with the incentive. The system will store incentive parameters such as store location, product, and incentive amount, in order to facilitate re-entry of the same or similar incentives in the future.

### Incentive Database

The issuer portal may allow the merchant standard-user 220 to finalize the incentive 260. The host system may then add the incentive to an incentive database 265, along with any associated specifications such as use limitations, user specifications, and value determinations. The database may be searchable and accessible through both the issuer portal and the consumer portal.

### Determining Incentive Value

The issuer portal allows the merchant standard-user 220 to give consumer users higher value incentives based on the consumer user performing certain tasks or exhibiting certain types of behavior. These tasks and behaviors may include sharing an incentive with others via various electronic means such as e-mail or social networking sites, providing certain information to the system, viewing, saving, or redeeming incentives or buying certain items.

### Incentive Fees

Advertising fees can be determined by various factors, such as the type of incentive, the number of redemptions, the number of consumer users to which the incentive is displayed, the rank position in search results, and the value of products or services bought. The incentive issuing company 200 may be charged a fee to enter the incentive into the database, to finalize the incentive 255 and then a variable fee depending on any of the above factors.

### Personalized Shopping Lists Determine Incentive Presentation

As seen in step 305, a consumer user may access the system through a personalized account via the consumer portal, which can be presented as a website, mobile device application, or through similar means. When the consumer user connects to the consumer portal, the consumer user may access the available incentives directly by product name, store name, manufacturer, or zip code. The consumer user can then directly store the incentive to their bundle for later use. If the consumer user selects an incentive that can be redeemed online, the consumer user will have the option to use the incentive immediately through a website link or code.

### Shopping Lists

The consumer user may also create or modify a product list such as a shopping list or wish list, as shown in step 310. The consumer user may make customized lists such as groceries, clothes, drinks, etc. The system will store items previously entered in the list in order to auto-complete future entries, as shown in step 320. The consumer user can also manually create templates for regularly purchased products, such as monthly groceries. When a consumer user accesses a template, this creates a new, editable list. In addition to consumer user created templates, the consumer portal will automatically create a template when it detects that certain items are included in product lists. Further, if an incentive is selected based on a product list, then the template may include that specific product name in the template, as shown in step 345. The incentive may then be automatically added to the consumer's coupon bundle 350.

The consumer may also be presented with items associated with particular list items. The issuer portal may allow the merchant standard-user 220 to display associated incentives when a consumer user adds particular items to his or her list. For example, the merchant standard-user 220 might associate complimentary food items together, such as salmon with pasta or broccoli, or items sold by the same company. In this example, when a consumer user adds salmon to their list, the consumer portal would also display an incentive for pasta or broccoli. This association could be based on food groupings such as Italian, Asian, Fast Food, or similar groupings. The association may also be based on ingredients in a particular recipe. The association may also be based on any other criteria as determined by the merchant standard-user 220.

### Presentation and Selection of Incentives

Product lists and templates are stored on the host server, as shown in step 325. The system selects keywords based on the user defined and automatically generated product lists, which the server matches to the list of incentives, as shown in step 330. Incentives can be matched by a “smart” program based on relevancy, past usage by the consumer user, relationship between complimentary products, the average time it takes to consume certain types of products, and overall product popularity. For example, an incentive for a product that can be consumed in one week might show up higher on the list than an incentive for a product that takes a few weeks to consume.

The system can also rank displayed incentives based on a bidding system between advertisers. The bidding system can involve an issuing company setting a budget and a price per click, where the highest paying price per click incentive is displayed more prominently until the budget runs out.

Selected incentives are then displayed to the consumer user through the consumer portal, as shown in step 335, such as through the website or on a mobile device. The consumer user may then select from the presented incentives or search the database of incentives, as shown in step 340. The user may also electronically announce the availability, selection, or use of an incentive, such as through a social networking website, as shown in step 340. The user may also electronically share the incentive with a second consumer user, such as through the consumer portal or a social networking website, as shown in step 340. Numerous available technologies known in the art are available to share electronic information. Briefly, a consumer user may provide his or her login information for a particular social networking site. The consumer user selects the share option associated with the particular incentives that the consumer user wishes to share. Once selected, the coupon or list item is shown on the social networking site, possibly with prepackaged text. A further example includes the consumer user opting to share an incentive, which results in a tweet that broadcasts “John just found a great coupon for Tide: $3 off a 48 oz bottle. Click here to get it too,” where the “click here” is a hyperlinked to access the particular incentive through the consumer portal. Further, the first consumer user could receive credit for sharing the coupon.

The consumer portal allows the consumer user to receive increasingly better incentives by performing certain tasks or exhibiting certain types of behavior. These tasks and behaviors may include sharing an incentive with others via various electronic means such as e-mail or social networking sites, providing certain information to the system, viewing, saving, or redeeming incentives, or buying certain items.

Upon selection of a particular incentive, as shown in step 345, the product name automatically replaces the list item that the host server matched. For example, if the user entered “cereal” in the product list and then selected an incentive for “Cheerios®”, then the word “cereal” would be replaced by “Cheerios®” on the product list. Further, the list item will be replaced by the product name in template and all future lists created by that template, unless modified by the consumer user.

The consumer portal presents relevant incentives based on the proximity of the consumer user to a particular retail establishment, a preselected list of preferred retail establishments, or based on a particular product. If the consumer user chooses retail establishment proximity, the system presents: a list of local stores, the distance to each store, the number of incentives available at each store, and the maximum amount they could save at each store based on product list. The consumer portal allows the location of the consumer user to be set through a “home address” associated with the personalized account, by manually entering locational information such as a zip code, address, area code, phone number; or by using a location aware mobile device such as global positioning satellites (GPS) or cellular network antenna positioning.

If the consumer user chooses to display incentives based on a particular product, the consumer portal will display available incentives and the retail stores where the incentive can be redeemed. If an internet based advertiser was available on the system, the list will provide a link to the website of the advertiser.

### Additional Incentives While Shopping

A consumer user accessing the system on a mobile device can access a shopping interface, as shown in step 355. The consumer portal can present the consumer user with the relevant list items for the current store, which enables consumers to indicate which items have been acquired, such as by striking through or checking off list items as they shop. The consumer user can also access a list of incentives available at that particular retail store and add additional incentives to their bundle, as shown in step 360. The consumer user may also remove incentives from their bundle if they decide not to use the incentive once they are in the retail store.

### Redeeming Incentives

A consumer user shopping with their mobile device will select a “Checkout” option, as shown in step 365, to indicate that they have completed their shopping. The consumer portal will display a confirmation prompt, confirming the consumer user wants to checkout and that there are no unused incentives in their bundle. The system will then store the incentive and consumer user location information. This information will be used by the incentive wizard to aid in preselecting incentives for this particular consumer user and other consumer users with similar demographic information. The incentive information may be transferred from the host system to the retail server and issuer server

### Single Incentive Bundles

After the user selects the checkout option, as shown in step 402, the incentive bundles that consist of only a single incentive will be sent directly through the host's server to the issuer's server, as shown in step 404. The system will also apply any restrictions that the advertiser included with the incentive use, such as if the incentive is only for a single use. Once the consumer uses a single use incentive, the incentive will no longer be accessible or available to the consumer.

The host server sends a selected incentive to the issuer server, as shown in step 406. The host server displays the selected incentive in the consumer portal, which may be accessed by a mobile device, as shown in step 408. The incentive number displayed on the consumer portal is entered at the point of sale in the retail store, as shown in step 412. The incentive number can be displayed as any alphanumeric representation or code symbolizing an alphanumeric representation, such as a bar code, semacode, QR code, Maxicode, shotCode or any alphanumeric coding system. This number can then be communicated from the point of sale station to the store server, as shown in step 414.

The issuer receives the incentive number from the host server, as shown in step 410. The issuer server validates and matches the incentive number to the incentive number transmitted to the issuer server in step 406, as shown in step 416. The issuer server transmits a confirmation code to the retail server and the customer is given credit for the incentive, as shown in step 418. The retail server confirms to the issuer server that the consumer used the incentive in a completed transaction, as shown in steps 420, 422. The issuer server or the retail server sends the incentive number to the host server as well, as shown in step 424. This allows the issuer and host server to identify the purchase location, timing, items sold, and customer information.

### Multiple Incentive Bundles

When a consumer user selects multiple incentives, the system will create an incentive bundle. Bundles that consist of multiple incentives will be processed differently. In one embodiment, the consumer confirms the “Checkout” option, as shown in step 500, and then all selected incentives are sent to the host server, as shown in step 505. The host server will then create a bundle number to identify the combination of incentive codes, as shown in step 510. The host server can then send the bundle number to the consumer portal, as shown in step 515, where it may appear on a consumer's mobile device, as shown in step 520. When displayed on a consumer's mobile device, the mobile device may be shown to the cashier working at the point of sale system, who may enter the code, as shown in step 530. The host server can also send the bundle number and the individual incentive codes to the issuer server, as shown in step 525. The issuer server associates the bundle number with the individual incentive information in order to identify the consumer's use of all of the incentives, as shown in step 530.

In another embodiment, the consumer confirms the “Checkout” option and then the individual incentive numbers contained in the bundle are sent to the issuer server. The issuer server will then create a bundle number to identify the combination of incentive codes. The issuer server can then send the bundle number to the host server, which displays the bundle number through the consumer portal.

The store cashier may then enter the bundle number at the point of sale, as shown in step 535. The point of sale system or the retail server can then send the bundle number to the issuer server, as shown in step 540. The issuer server will match the bundle number with the associated bundle of incentives.

The issuer server validates and matches the bundle number to the incentive numbers transmitted to the issuer server in step 525, as shown in step 545. The issuer server sends the individual incentive numbers associated with that bundle number in step 530 to the retail server and point of sale device, as shown in step 550. The customer is given credit for the incentive at the point of sale system, as shown in step 560. The retail server confirms to the issuer server that the consumer used the incentive in a completed transaction, as shown in step 565. The issuer server or the retail server sends the incentive number to the host server as well, as shown in step 570. This allows the issuer and host server to identify the purchase location, timing, items sold, and customer information, which is used for future incentive use prediction, as shown in step 575.

In another embodiment, the consumer will associate their loyalty card program number with their personalized account. Many large retailers have a loyalty card program that associates incentives and customer purchases with an individual consumer. This eliminates the need for a bundle number to appear on the mobile device and for the store cashier to type the bundle number in to the point of sale station. The system will associate a user's bundle number directly to their loyalty card number. When the loyalty card number is registered at the point of sale station, the store server will transfer the loyalty card number to the host server. The host server can then direct the group of incentive numbers associated with the loyalty card number to be routed to the correct point of sale station. The consumer will then be credited for the amount of the incentives in their bundle.

What is claimed is:

1. A data processing system for issuing and redeeming incentives comprising:
A) a host server, wherein the host server comprises;
an issuer portal, wherein the issuer portal is configured to allow a merchant to generate an incentive and a plurality of specifications associated with the incentive;
an incentive database, wherein the incentive database comprises a plurality of incentives;
a consumer portal, wherein the consumer portal is configured to allow a first consumer user to create a list of products;
wherein the host server is configured to produce at least one matched incentive by comparing the list of products to the incentive database; and
wherein the consumer portal is further configured to allow the first consumer user to make a selection from the at least one matched incentives;
B) an issuer server,
wherein the issuer server is configured to receive the selection from the host server;
wherein the issuer server is further configured to verify the selection; and
wherein the issuer server is further configured to transmit a verification confirmation;
C) a point of sale system,
wherein the point of sale system is configured to receive the selection from the consumer portal; and
wherein the point of sale system is further configured to deduct a value associated with the selection upon receiving the verification confirmation;
D) a retail server,
wherein the retail server is configured to receive the verification confirmation from the issue server and transmit the verification confirmation to the point of sale system; and
E) a network,
wherein the network is configured to provide for transmission between the host server, the issuer server, and the retail server.

2. The data processing system of claim 1, wherein the consumer portal is accessible by a mobile device.

3. The data processing system of claim 1, wherein the consumer portal is accessible by a website.

4. The data processing system of claim 1, wherein the consumer portal is further configured to display the selection.

5. The data processing system of claim 1, wherein the plurality of specifications includes at least one factor for determining the value of the incentive.

6. The data processing system of claim 5, wherein the factor for determining the value of the incentive is a consumer activity.

7. The data processing system of claim 6, wherein the consumer activity is selected from the group consisting of electronically sharing the incentive, providing information to the host server, viewing, saving, redeeming a second incentive or buying an item.

8. The data processing system of claim 1, wherein the issuer portal is further configured to display the total cost of delivering the incentive based on the plurality of specifications.

9. The data processing system of claim 8, wherein the issuer portal is further configured to display selectable parameters for reducing the cost of the incentive by limiting the number of consumer users to which the incentive can be presented.

10. The data processing system of claim 1, wherein the selection includes a plurality of incentives;
wherein the host server is further configured to create a bundle code to represent the plurality of incentives;
wherein the host server is further configured to transmit the bundle code to the issuer server;
wherein the consumer portal is further configured to display the bundle code;
wherein the issuer server is further configured to receive the bundle code;
wherein the issuer server is further configured to transmit the plurality of incentives to the retail server;
wherein the point of sale system is further configured to receive the bundle code from the consumer portal;
wherein the retail server is further configured to receive the bundle code from the point of sale system;
wherein the retail server is further configured to transmit the bundle code to the host server;
wherein the retail server is further configured to receive the plurality of incentives from the host server;
wherein the point of sale system is further configured to receive the plurality of incentives from the retail server; and
wherein the point of sale system is further configured to deduct the value associated with the plurality of incentives.

11. The data processing system of claim 1, wherein the selection includes a plurality of incentives;
wherein the issuer server is further configured to receive the plurality of incentives from the host server;
wherein the issuer server is further configured to assign a bundle code to the plurality of selected incentives, and
wherein the point of sale system is further configured to receive the bundle code from the consumer portal;
wherein the retail server is further configured to receive the bundle code from the point of sale system;
wherein the retail server is further configured to transmit the bundle code to the issuer server;
wherein the retail server is further configured to receive the plurality of incentives from the issuer server;
wherein the point of sale system is further configured to receive the plurality of incentives from the retail server; and
wherein the point of sale system is further configured to deduct the value associated with the plurality of incentives.

12. The data processing system of claim 1, wherein the personalized user account comprises a store loyalty program account.

13. The data processing system of claim 1,
wherein the consumer portal allows the first consumer user to share the selected incentive with a second consumer through a social networking site; and
wherein the plurality of specifications includes whether the first consumer user has shared the selected incentive.

14. A data processing system for issuing and redeeming incentives comprising:
A) a host server, wherein the host server comprises;
an issuer portal, wherein the issuer portal is configured to allow a merchant to establish an issuer account and to generate an incentive and a plurality of specifications associated with the incentive;
an incentive database, wherein the incentive database comprises a plurality of incentives;
a consumer portal, wherein the consumer portal is operably configured to allow a first consumer to establish a personalized account and to create a list of products;
wherein the host server is configured to produce at least one matched incentive by comparing the list of products with the incentive database;
wherein the consumer portal is configured to selectively display the matched incentive based on the plurality of specifications; and
wherein the consumer portal is further configured to allow the first consumer user to make a selection from the at least one matched incentives;
B) an issuer server,
wherein the issuer server is configured to receive the selection from the host server;
wherein the issuer server is further configured to verify the selection; and
wherein the issuer server is further configured to transmit a verification confirmation;
C) a point of sale system,
wherein the point of sale system is configured to receive the selection from the consumer portal; and
wherein the point of sale system is further configured to deduct a value associated with the selection upon receiving the verification confirmation;
D) a retail server,
wherein the retail server is further configured to transmit the selection to the issuer server; and
wherein the retail server is further configured to receive the verification confirmation from the issuer server and transmit the verification confirmation to the point of sale system; and
E) a network connection for transmitting incentive information between the host server, the issuer server, and the retail server.

15. The data processing system of claim 14, wherein the personalized account comprises a store loyalty program account.

16. The data processing system of claim 14,
wherein the host system is further configured to retain the list of products;
wherein the host system is further configured to create a list template from the list of products.

17. The data processing system of claim 14, wherein the host system is further configured to replace an item in the list of products with a specific product name associated with the selected incentive.

18. The data processing system of claim 14,
wherein the issuer portal is configured to associate a specific list item with a plurality of incentives for other items;
wherein the consumer portal is configured to display the plurality of incentives for other items when the consumer user selects the specific list item.

19. The data processing system of claim 18,
wherein the host system is further configured to identify at least one additional incentive available at the retail store; and
wherein the consumer portal is further configured to display the additional incentives available at the retail store.

20. A data processing system for issuing and redeeming incentives comprising:
A) a host server, wherein the host server comprises;
an issuer portal, wherein the issuer portal is configured to allow a merchant to generate one or more incentives;
a consumer portal, wherein the consumer portal is configured to allow a consumer user to create a list of products;
wherein the host server is configured to compare the list of products to the one or more incentives; and
wherein the consumer portal is further configured to allow the first consumer user to make a selection from the at least one matched incentives;
B) an issuer server,
wherein the issuer server is configured to receive the selection;
wherein the issuer server is further configured to verify the selection and to transmit a verification confirmation;
C) a point of sale system,
wherein the point of sale system is configured to receive the selection and deduct a value associate with the selection; and
D) a retail server,
wherein the retail server is configured to transfer information between the point of sale system and the network; and
E) a network,
wherein the network is configured to provide for transmission between the host server, the issuer server, and the retail server.
